(19) United States
(12) Patent Application Publication
(10) Pub. No.: US 2024/0141621 A1
(43) Pub. Date: May 2, 2024

(54) DISPLAY CONTROL DEVICE, DISPLAY CONTROL METHOD, AND WORK MACHINE

(71) Applicant: Komatsu Ltd., Tokyo (JP)

(72) Inventors: Taro Eguchi, Tokyo (JP); Koichi Nakazawa, Tokyo (JP)

(73) Assignee: Komatsu Ltd., Tokyo (JP)

(21) Appl. No.: 18/288,431

(22) PCT Filed: Apr. 27, 2022
(86) PCT No.: PCT/JP2022/019100

§ 371 Date: Oct. 26, 2023

(30) Foreign Application Priority Data
Apr. 28, 2021 (JP) 2021-075949

(51) Int. Cl. E02F 9/26; G06T 11/20

(52) U.S. Cl. CPC E02F 9/261; G06T 11/203

(57) ABSTRACT

One aspect of the present disclosure is a display control device, and the display control device includes: an overhead image-generating unit that generates an overhead image of a work machine including an undercarriage and an upper swiveling body swivelably supported by the undercarriage based on one or a plurality of captured images imaged by one or a plurality of imaging devices provided in the upper swiveling body; a superimposing unit that generates a display image in which an attention area image indicating a swiveling attention area accompanying swiveling of the upper swiveling body and a traveling attention area accompanying forward and backward movement of the undercarriage is superimposed on the overhead image; and a display image-outputting unit that outputs the display image.

### TECHNICAL FIELD

The present disclosure relates to a display control device, a display control method, and a work machine.

Priority is claimed on Japanese Patent Application No. 2021-075949 filed Apr. 28, 2021, the content of which is incorporated herein by reference.

### BACKGROUND ART

In a vision field-aiding device of a work machine described in Patent Document 1, the following display image is displayed on a display monitor provided inside the cab. That is, the display image shown in Patent Document 1 consists of an exterior image of the work machine viewed from above, an overhead view composite camera image around the machine body, and a plurality of camera images. The exterior image is composed of bitmap images preset for each model of the work machine and includes a swiveling body image denoting a swiveling body. A carriage image denoting a carriage is superimposed on the swiveling body image denoting the swiveling body. The exterior image is a fixed image, and in contrast, the carriage image rotates on the swiveling center as the swiveling body swivels.

### CITATION LIST

### Patent Document

[Patent Document 1] Japanese Unexamined Patent Application, First Publication No. 2010-59653

### SUMMARY OF INVENTION

### Technical Problem

According to the vision field-aiding device of the work machine described in Patent Document 1, it is possible to inform a driver of suitable vision field information, so that the driver can always see circumstances in the traveling direction. However, there is a problem that the driver cannot easily grasp an area to pay attention when the upper swiveling body of the work machine is swiveled with respect to surrounding obstacles or the like and an area to pay attention when the work machine is moved forward or backward by the undercarriage therewith.

The present disclosure is made in view of the above circumstances, and an object thereof is to provide a display control device, a display control method, and a work machine that allow a driver to easily grasp an area to pay attention accompanying the operation of the work machine.

### Solution to Problem

In order to solve the above problem, one aspect of the present disclosure is a display control device, and the display control device includes: an overhead image-generating unit that generates an overhead image around a work machine including an undercarriage and an upper swiveling body swivelably supported by the undercarriage based on one or a plurality of captured images imaged by one or a plurality of imaging devices provided in the upper swiveling body; a superimposing unit that generates a display image in which an attention area image indicating a swiveling attention area accompanying swiveling of the upper swiveling body and a traveling attention area accompanying forward and backward movement of the undercarriage is superimposed on the overhead image; and a display image-outputting unit that outputs the display image.

### Advantageous Effects of Invention

According to each aspect of the present disclosure, a driver can easily grasp an area to pay attention accompanying the operation of a work machine.

### BRIEF DESCRIPTION OF DRAWINGS

FIG. 1 is a schematic diagram showing a configuration of a work machine according to an embodiment.

FIG. 2 is a plan view schematically showing imaging areas of a plurality of cameras provided in the work machine according to the embodiment.

FIG. 3 is a diagram showing a configuration of the inside of a cab according to the embodiment.

FIG. 4 is a schematic block diagram showing a configuration of a display control system.

FIG. 5 is a diagram showing an example of a display screen according to the embodiment.

FIG. 6 is a diagram showing an example of the display screen according to the embodiment.

FIG. 7 is a diagram showing an example of the display screen according to the embodiment.

FIG. 8 is a flowchart showing the operation of a display control device according to the embodiment.

FIG. 9 is a diagram showing another example of the display screen according to the embodiment.

FIG. 10 is a diagram showing another example of the display screen according to the embodiment.

### DESCRIPTION OF EMBODIMENTS

An embodiment of the present disclosure is described below with reference to the drawings. Equal components or corresponding components in the drawings have equal reference signs, and the descriptions thereof are omitted as appropriate.

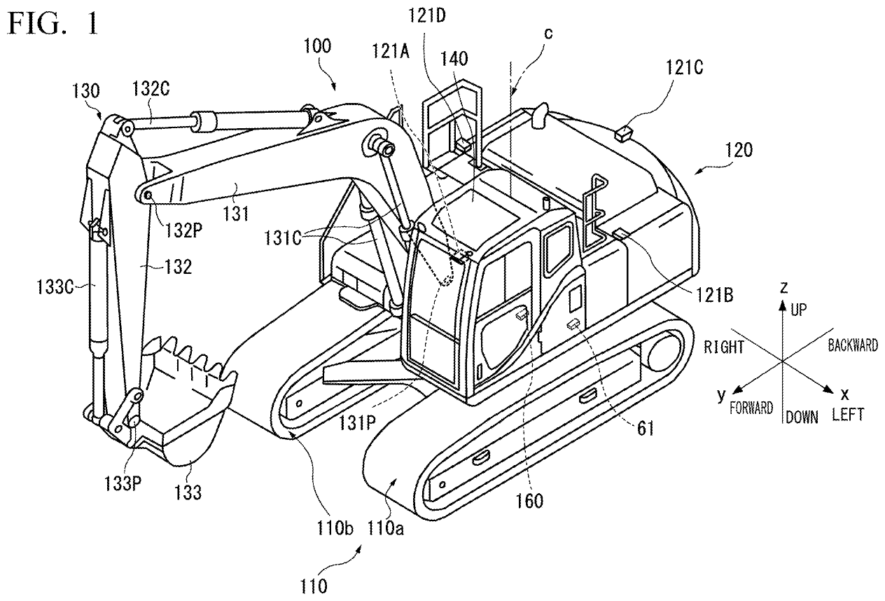

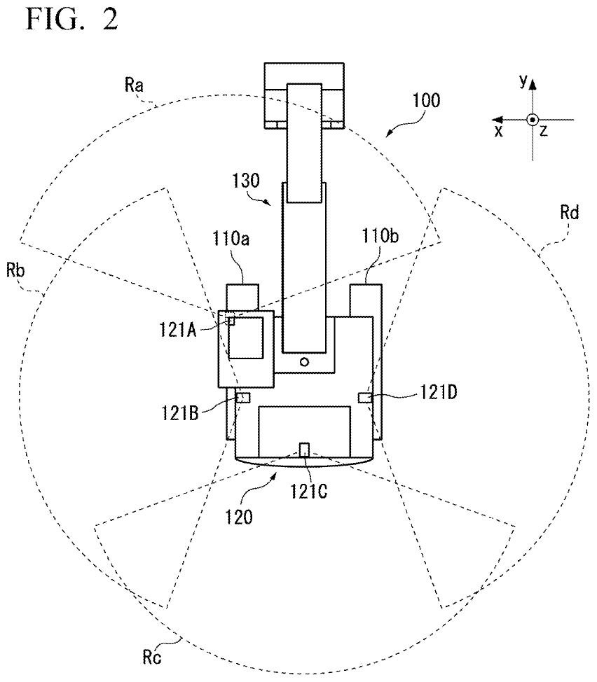

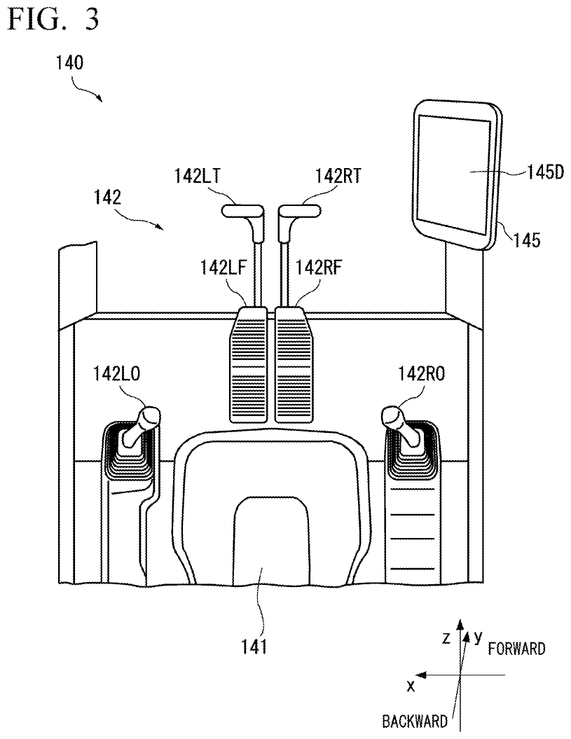

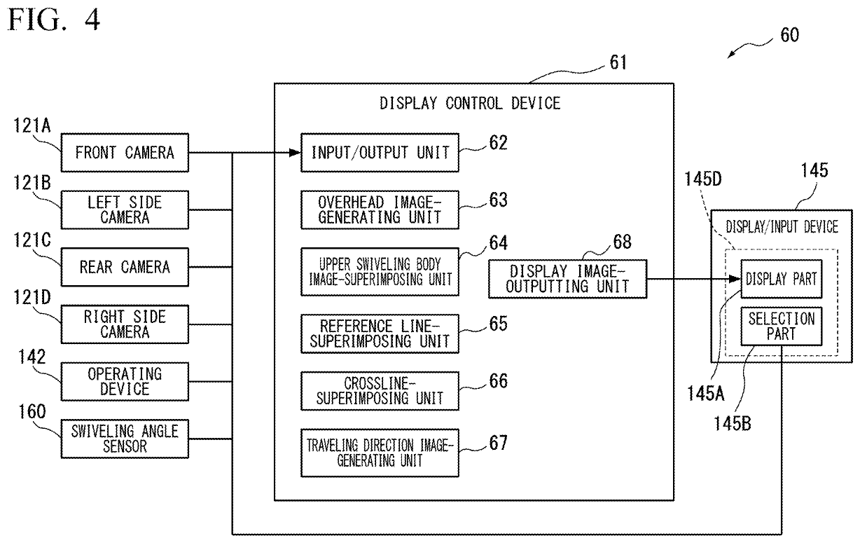

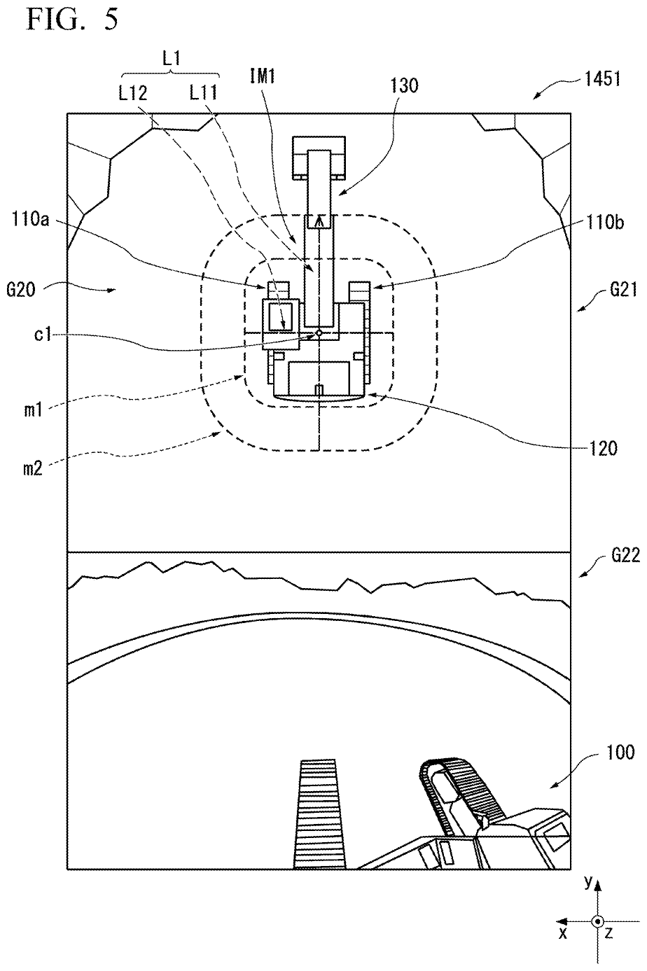

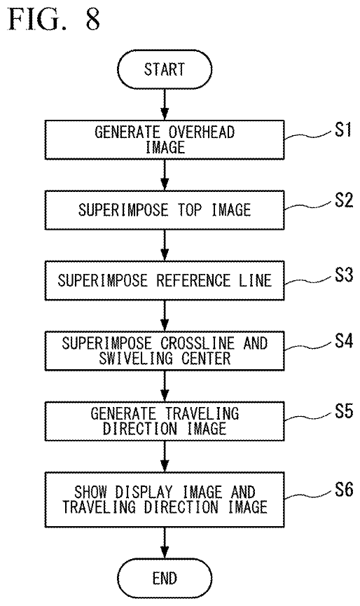

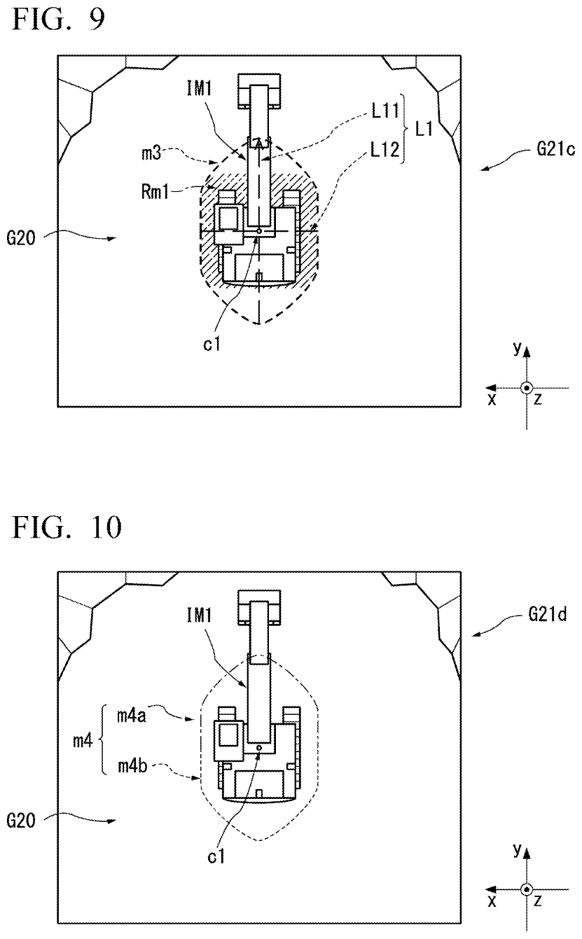

FIG. 1 is a schematic diagram showing a configuration of a work machine 100 according to the embodiment. FIG. 2 is a plan view schematically showing imaging areas of a plurality of cameras (i.e., imaging devices) 121A to 121D provided in the work machine 100 according to the embodiment. FIG. 3 is a diagram showing a configuration of the inside of a cab 140 according to the embodiment. FIG. 4 is a schematic block diagram showing a configuration example of a display control system 60. FIGS. 5 to 7 are diagrams showing examples of a display screen according to the embodiment. FIG. 8 is a flowchart showing an operation example of a display control device 61 according to the embodiment. FIGS. 9 and 10 are diagrams showing other examples of the display screen according to the embodiment.

As shown in FIG. 1, in the present embodiment, a local coordinate system is set for the work machine 100, and the positional relationship of each portion is described with reference to the local coordinate system. In the local coordinate system, a first axis that extends in a left-right direction (i.e., a machine width direction) of the work machine 100 (or an upper swiveling body 120) is referred to as an x-axis, a second axis that extends in a forward-backward direction of the work machine 100 is referred to as a y-axis, and a third axis that extends in an up-down direction of the work machine 100 is referred to as a z-axis. The x-axis and the y-axis are orthogonal. The y-axis and the z-axis are orthogonal. The z-axis and the x-axis are orthogonal. The arrow direction of the x-axis denotes a leftward direction, and the opposite direction thereto denotes a rightward direction. The arrow direction of the y-axis denotes a forward direction, and the opposite direction thereto denotes a backward direction. The arrow direction of the z-axis denotes an upward direction, and the opposite direction thereto denotes a downward direction.

(Configuration Example of Work Machine 100)

FIG. 1 shows a configuration example of the work machine 100 according to the embodiment. The work machine 100 operates in a work site and performs work for working objects such as earth and sand. The work machine 100 according to the embodiment is a hydraulic excavator as an example. The work machine 100 includes an undercarriage 110, the upper swiveling body 120, and a work tool 130. The upper swiveling body 120 is equipped with the cab 140 and the display control device 61.

The undercarriage 110 travelably supports the work machine 100. The undercarriage 110 includes, for example, a pair of crawlers on left and right sides, i.e., a crawler 110a (also referred to as a left crawler 110a) and a crawler 110b (also referred to as a right crawler 110b).

The upper swiveling body 120 is supported by the undercarriage 110 so as to be swivelable on a swiveling center c. The work tool 130 is hydraulically driven. The work tool 130 is supported on the front of the upper swiveling body 120 so as to be drivable in the up-down direction. The cab 140 is a space that an operator (i.e., a driver) boards and for operating the work machine 100. The cab 140 is provided in a front left portion of the upper swiveling body 120. A portion of the upper swiveling body 120 to which the work tool 130 is attached is referred to as a front portion. In the upper swiveling body 120, an opposite portion to the front portion is referred to as a rear portion, a portion on the left side of the front portion is referred to as a left portion, and a portion on the right side of the front portion is referred to as a right portion.

In the crawlers 110a and 110b on the left and right sides, driving wheels thereof can be independently driven (forward and backward drive). The undercarriage 110 moves forward when the left crawler 110a and the right crawler 110b are driven forward at the same time and moves backward when the left crawler 110a and the right crawler 110b are driven backward at the same time. When the driving wheel of one crawler and the driving wheel of the other crawler are driven in opposite directions to each other, for example, when the right crawler 110b is driven forward and the left crawler 110a is driven backward at the same time, the undercarriage 110 can turn on a turning center. Such a turning method is called counter-rotation turn.

The turning center at the time the undercarriage 110 is made to perform the counter-rotation turn may be caused to match or be different from the swiveling center c of the upper swiveling body 120. The “swiveling center” shown in the claims of the present application may be either the turning center at the time the counter-rotation turn is performed or the swiveling center c of the upper swiveling body 120.

The work machine 100 includes a swiveling angle sensor 160. The swiveling angle sensor 160 measures the swiveling angle of the upper swiveling body 120 relative to the undercarriage 110 from a predetermined reference angle. The swiveling angle sensor 160 is used to grasp the relative positional relationship between the upper swiveling body 120 and the undercarriage 110. The swiveling angle sensor 160 can be configured of, for example, a rotary potentiometer, a rotary encoder or the like.

(Configuration Example of Camera)

The upper swiveling body 120 is provided with a plurality of cameras (i.e., a front camera 121A, a left side camera 121B, a rear camera 121C, and a right side camera 121D) that image the surroundings of the work machine 100. In the example shown in FIG. 1, the front camera 121A is provided inside the cab 140. The front camera 121A, the left side camera 121B, the rear camera 121C, and the right side camera 121D are collectively referred to as the plurality of cameras 121A to 121D. FIG. 2 schematically shows imaging areas of the plurality of cameras 121A to 121D provided in the work machine 100 according to the embodiment.

Specifically, the upper swiveling body 120 is provided with the front camera 121A that images a front area Ra of the surroundings of the upper swiveling body 120, the left side camera 121B that images a left side area Rb of the surroundings of the upper swiveling body 120, the rear camera 121C that images a rear area Rc of the surroundings of the upper swiveling body 120, and the right side camera 121D that images a right side area Rd of the surroundings of the upper swiveling body 120. Parts of the imaging areas of the plurality of cameras 121A to 121D may overlap each other or may not overlap. For example, one omnidirectional camera or the like may be used instead of the plurality of cameras 121A to 121D or together with the plurality of cameras 121A to 121D.

The imaging areas of the plurality of cameras 121A to 121D are not limited to the example shown in FIG. 2. For example, imaging of the front left area that is visible from the cab 140 may not be performed. The number and the imaging areas of the plurality of cameras 121A to 121D may be different from the example shown in FIGS. 1 and 2.

(Configuration Example of Work Tool 130)

The work tool 130 includes a boom 131, an arm 132, a bucket 133, a boom cylinder 131C, an arm cylinder 132C, and a bucket cylinder 133C.

The base end portion of the boom 131 is attached to the upper swiveling body 120 through a boom pin 131P. The arm 132 connects the boom 131 and the bucket 133 to each other. The base end portion of the arm 132 is attached to the tip portion of the boom 131 through an arm pin 132P. The bucket 133 includes a blade for excavating earth and sand, and an accommodating portion for accommodating the excavated earth and sand. The base end portion of the bucket 133 is attached to the tip portion of the arm 132 through a bucket pin 133P.

The boom cylinder 131C is a hydraulic cylinder for operating the boom 131. The base end portion of the boom cylinder 131C is attached to the upper swiveling body 120. The tip portion of the boom cylinder 131C is attached to the boom 131.

The arm cylinder 132C is a hydraulic cylinder for driving the ami 132. The base end portion of the arm cylinder 132C is attached to the boom 131. The tip portion of the arm cylinder 132C is attached to the arm 132.

The bucket cylinder 133C is a hydraulic cylinder for driving the bucket 133. The base end portion of the bucket cylinder 133C is attached to the arm 132. The tip portion of the bucket cylinder 133C is attached to a link member connected to the bucket 133.

(Configuration Example of Cab 140)

FIG. 3 shows a configuration example of the inside of the cab 140 according to the embodiment. Inside the cab 140, a cab seat 141, an operating device 142, and a display/input device 145 are provided.

The operating device 142 is a device for driving the undercarriage 110, the upper swiveling body 120 and the work tool 130 through the manual operation of the operator. The operating device 142 includes a left operating lever 142LO, a right operating lever 142RO, a left foot pedal 142LF, a right foot pedal 142RF, a left travel lever 142LT, and a right travel lever 142RT.

The left operating lever 142LO is provided on the left side of the cab seat 141. The right operating lever 142RO is provided on the right side of the cab seat 141.

The left operating lever 142LO is an operating mechanism for performing swiveling motion of the upper swiveling body 120 and excavating/dumping motion of the arm 132. Specifically, when the operator of the work machine 100 tilts the left operating lever 142LO forward, the arm 132 performs the dumping motion. When the operator of the work machine 100 tilts the left operating lever 142LO backward, the arm 132 performs the excavating motion. When the operator of the work machine 100 tilts the left operating lever 142LO rightward, the upper swiveling body 120 swivels right. When the operator of the work machine 100 tilts the left operating lever 142LO leftward, the upper swiveling body 120 swivels left. In another embodiment, when the left operating lever 142LO is tilted in the forward-backward direction, the upper swiveling body 120 may swivel right or left, and when the left operating lever 142LO is tilted in the left-right direction, the arm 132 may perform the excavating motion or the dumping motion.

The right operating lever 142RO is an operating mechanism for performing excavating/dumping motion of the bucket 133 and lifting/lowering motion of the boom 131. Specifically, when the operator of the work machine 100 tilts the right operating lever 142RO forward, the lowering motion of the boom 131 is performed. When the operator of the work machine 100 tilts the right operating lever 142RO backward, the lifting motion of the boom 131 is performed. When the operator of the work machine 100 tilts the right operating lever 142RO rightward, the dumping motion of the bucket 133 is performed. When the operator of the work machine 100 tilts the right operating lever 142RO leftward, the excavating motion of the bucket 133 is performed. In another embodiment, when the right operating lever 142RO is tilted in the forward-backward direction, the bucket 133 may perform the dumping motion or the excavating motion, and when the right operating lever 142RO is tilted in the left-right direction, the boom 131 may perform the lifting motion or the lowering motion.

The left foot pedal 142LF is disposed on the left side of a floor in front of the cab seat 141. The right foot pedal 142RF is disposed on the right side of the floor in front of the cab seat 141. The left travel lever 142LT is pivotally supported by the left foot pedal 142LF, and the left travel lever 142LT and the left foot pedal 142LF are configured such that the tilting of the left travel lever 142LT and the pushing down of the left foot pedal 142LF are interlocked. The right travel lever 142RT is pivotally supported by the right foot pedal 142RF, and the right travel lever 142RT and the right foot pedal 142RF are configured such that the tilting of the right travel lever 142RT and the pushing down of the right foot pedal 142RF are interlocked.

The left foot pedal 142LF and the left travel lever 142LT correspond to the rotational drive of the left crawler 110a of the undercarriage 110. Specifically, when the operator of the work machine 100 tilts the left foot pedal 142LF or the left travel lever 142LT forward, the left crawler 110a rotates in the forward direction. When the operator of the work machine 100 tilts the left foot pedal 142LF or the left travel lever 142LT backward, the left crawler 110a rotates in the backward direction.

The right foot pedal 142RF and the right travel lever 142RT correspond to the rotational drive of the right crawler 110b of the undercarriage 110. Specifically, when the operator of the work machine 100 tilts the right foot pedal 142RF or the right travel lever 142RT forward, the right crawler 110b rotates in the forward direction. When the operator of the work machine 100 tilts the right foot pedal 142RF or the right travel lever 142RT backward, the right crawler 110b rotates in the backward direction.

The display/input device 145 is a device that displays information relating to a plurality of functions that the work machine 100 has and that inputs various instruction operations. The display/input device 145 includes a display 145D. The display 145D is configured of, for example, a touch panel or the like.

(Configuration Example of Display Control System 60)

FIG. 4 shows a configuration example of the display control system 60 according to the embodiment. The display control system 60 includes the display control device 61, the plurality of cameras 121A to 121D, the operating device 142, the swiveling angle sensor 160, and the display/input device 145.

The display/input device 145 includes a display part 145A and a selection part 145B as functional components configured by a combination of hardware constituting the display 145D and software such as a program that controls the hardware. The display part 145A displays, according to instructions from the display control device 61, an instructed image on the display 145D. The selection part 145B selects between setting for displaying a crossline described below and setting for not displaying the crossline according to the input operation of the operator on, for example, the display 145D.

The display control device 61 can be configured using a computer such as a microcomputer and a CPU (Central Processing Unit), and hardware such as peripheral circuits and peripheral devices of the computer. The display control device 61 includes an input/output unit 62, an overhead image-generating unit 63, an upper swiveling body image-superimposing unit 64, a reference line-superimposing unit 65, a crossline-superimposing unit 66, a traveling direction image-generating unit 67, and a display image-outputting unit 68 as functional components configured by a combination of hardware and software such as a program that the computer executes.

The display control device 61 and the display/input device 145 may be configured using a custom LSI (Large Scale Integrated circuit) such as a PLD (Programmable Logic Device). Examples of the PLD include a PAL (Programmable Array Logic), a GAL (Generic Array Logic), a CPLD (Complex Programmable Logic Device), and an FPGA (Field Programmable Gate Array). In this case, part or all of the functions implemented by the processor may be implemented by the integrated circuit.

For example, the display 145D and the operating device 142 may be configured to be provided in a remote control room disposed remotely from the work machine 100.

The input/output unit 62 repeats at a predetermined cycle to input image transmission signals indicating captured images imaged by the plurality of cameras 121A to 121D, to input operation information of the operating device 142, to input a signal indicating a swiveling angle measured by the swiveling angle sensor 160, and to input an input operation signal to the selection part 145B of the display/input device 145.

The overhead image-generating unit 63 generates an overhead image (refer to an overhead image G20 in FIG. 5) shown such that the surroundings of the work machine 100 are viewed from above based on images captured by the plurality of cameras 121A to 121D. Specifically, coordinate transformation of image data is performed using conversion information stored in a predetermined storage unit, so that images captured by the plurality of cameras 121A to 121D are converted into images projected onto a predetermined virtual projection plane from a virtual viewpoint positioned above the work machine 100, i.e., upper viewpoint images. The overhead image-generating unit 63 converts each image data captured by the four cameras 121A to 121D into an upper viewpoint image and then integrates converted image data to generate one overhead image showing an overhead view of the surroundings of the work machine 100. The overhead image-generating unit 63 integrates surrounding images with, for example, the swiveling center c as a reference. At that time, the overhead image-generating unit 63 generates the overhead image such that the front of the cab 140 always faces the top of the image. In the present embodiment, the overhead image-generating unit 63 generates an overhead image around the work machine 100 including the undercarriage 110 and the upper swiveling body 120 swivelably supported by the undercarriage 110 based on one or a plurality of captured images imaged by one or a plurality of cameras (i.e., imaging devices) 121A to 121D provided in the upper swiveling body 120.

For example, as shown in FIG. 5, the upper swiveling body image-superimposing unit 64 superimposes a top image IM1 prepared in advance of the upper swiveling body 120 and the work tool 130 on the overhead image G20 generated by the overhead image-generating unit 63. FIG. 5 shows a display example (i.e., a display screen 1451) of the display 145D. The display screen 1451 includes a display image G21 and a traveling direction image G22. In the display image G21, the top image IM1, reference line images m1 and m2, a crossline image L1, and a swiveling center image c1 are superimposed on the overhead image G20. The upper swiveling body image-superimposing unit 64 superimposes the top image IM1 of the work machine 100 on a central portion of the overhead image G20 generated by the overhead image-generating unit 63. Thereby, the operator who sees the display image G21 shown in FIG. 5 can easily grasp the positional relationship and the sense of distance between the surrounding obstacles or the like and the work machine 100 displayed in the overhead image G20. The overhead image G20 includes actual captured images of the crawlers 110a and 110b.

The reference line-superimposing unit 65 generates the reference line images m1 and m2 that are images indicating a swiveling attention area accompanying the swiveling of the upper swiveling body 120 and superimposes them on the overhead image G20. The reference line-superimposing unit 65 superimposes the reference line images m1 and m2 (e.g., rectangles with rounded corners) in, for example, a translucent state on the overhead image G20. The reference line image m1 and the reference line image m2 have, for example, different colors. The reference line image m1 is an image corresponding to, for example, the outer edge (i.e., the trajectory of the outermost portion) of the upper swiveling body 120 swiveling. If an obstacle or the like is positioned in an area shown by the reference line image m1, when the upper swiveling body 120 swivels, the area has a higher possibility that contact, interference, collision or the like occurs between the upper swiveling body 120 and the obstacle than that of the outside of the area, and thus the reference line image m1 is an image showing an area (i.e., the swiveling attention area) for the operator to pay attention. In the present embodiment, the term “attention” means carefully looking, paying particular attention or the like and may be read as “caution”, “notice”, “warning”, “precaution” or the like. The reference line image m2 is an image showing an area that is further away from the upper swiveling body 120 than the reference line image m1 by a fixed distance (e.g., 2 to 3 m). For example, the reference line image m1 indicates an area to pay attention accompanying the swiveling, and the reference line image m2 indicates an area to pay attention accompanying the swiveling, whose need for attention is lower than that of the area indicated by the reference line image m1. The area indicated by the reference line image m1 and the area indicated by the reference line image m2 may be, for example, areas corresponding to a stop control area and a deceleration control area outside thereof through automatic control by automatic detection of obstacles or the like, areas corresponding to a warning area and a caution area outside thereof, or areas corresponding to a stop determination area and a deceleration determination area outside thereof.

The crossline-superimposing unit 66 generates the crossline image L1 and the swiveling center image c1 that is an image showing the swiveling center c based on the swiveling angle measured by the swiveling angle sensor 160 and superimposes them on the overhead image G20. The crossline-superimposing unit 66 superimposes the crossline image L1 in, for example, a translucent state on the overhead image G20. The swiveling center image c1 is an image having a predetermined shape showing the swiveling center c, such as a translucent or non-translucent circle having a specific color. The crossline image L1 is an image (i.e., an attention area image) showing a traveling attention area accompanying the forward and backward movement of the undercarriage 110 and the swiveling attention area accompanying the swiveling of the upper swiveling body 120. If an obstacle or the like is positioned in an area (i.e., a width and a length) indicated by the crossline image L1, when the undercarriage 110 is moved forward or backward (or when the upper swiveling body 120 is swiveled while the undercarriage 110 is moved forward or backward) in a direction (i.e., the forward direction or the backward direction) indicated by the crossline image L1, the area has a higher possibility that contact or the like occurs between the upper swiveling body 120 or the like and the obstacle than that of the outside of the area, and thus the traveling attention area accompanying the forward and backward movement of the undercarriage 110 is an area for the operator to pay attention. In the example shown in FIG. 5, the crossline image L1 includes an arrow image L11 and a line image L12. Alternatively, the crossline image L1 includes the arrow image L11, the line image L12, and the swiveling center image c1. The crossline-superimposing unit 66 superimposes or stops superimposing the crossline image L1 according to the selection operation by the selection part 145B.

The arrow image L11 indicates, by the direction of the arrow, the direction of traveling of the undercarriage 110 when the operator of the work machine 100 tilts the left foot pedal 142LF or the left travel lever 142LT and the right foot pedal 142RF or the right travel lever 142RT forward at the same time. The arrow image L11 also indicates the length of the traveling attention area by the length of the arrow. The line image L12 shows a line crossing the arrow of the arrow image L11 at the swiveling center c of the work machine 100 and indicating a length corresponding to the swiveling attention area. In the example shown in FIG. 5, the arrow image L11 and the line image L12 are orthogonal to each other at the position of the swiveling image c1, the arrow image L11 has a length such that the arrow is in contact with the reference image m2, and the line image L12 has a length such that the line is in contact with the reference image m1.

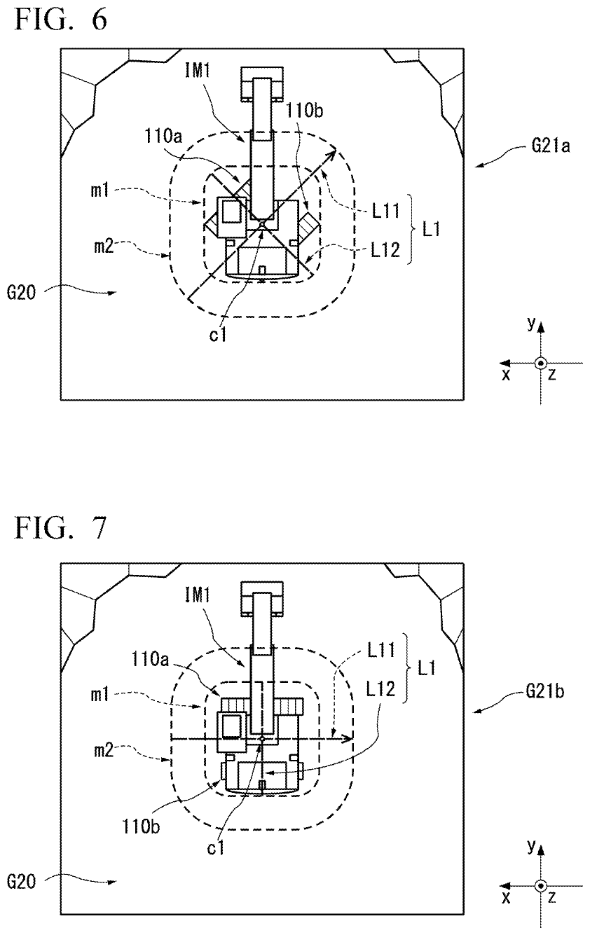

FIG. 6 shows a display image G21a in a state where the undercarriage 110 is turned 45 degrees to the right from the state shown in FIG. 5. FIG. 7 shows a display image G21b in a state where the undercarriage 110 is turned 90 degrees to the right from the state shown in FIG. 5.

In the present embodiment, the crossline-superimposing unit 66 (i.e., a superimposing unit) generates the display image G21 in which the crossline image L1 (i.e., the attention area image) indicating the swiveling attention area accompanying the swiveling of the upper swiveling body 120 and the traveling attention area accompanying the forward and backward movement of the undercarriage 110 is superimposed on the overhead image G20. The crossline image L1 shows information (i.e., the arrow direction of the crossline image L1) indicating a direction corresponding to a predetermined instruction operation of forward or backward movement for the operating device 142 for operating the undercarriage 110 (i.e. an operation in which the operator of the work machine 100 tilts the left foot pedal 142LF or the left travel lever 142LT and the right foot pedal 142RF or the right travel lever 142RT forward at the same time). The crossline image L1 includes an image (i.e., the arrow image L11) that shows an arrow indicating a length corresponding to the traveling attention area and a direction corresponding to the above predetermined instruction operation, and an image (i.e., the line image L12) that shows a line crossing the arrow (i.e., the arrow shown by the arrow image L11) at the swiveling center c of the work machine 100 and indicating a length corresponding to the swiveling attention area.

The traveling direction image-generating unit 67, for example, when a predetermined instruction operation instructing the operating device 142 in forward or backward movement is performed, generates a traveling direction image corresponding to an area in the traveling direction of the undercarriage 110 based on captured images of the one or the plurality of cameras 121A to 121D. The traveling direction image G22 shown in FIG. 5 is an image displayed when an instruction operation instructing the work machine 100 to move forward in the state displayed in the display image G21 is performed on the operating device 142. In this case, the traveling direction image G22 is, for example, the captured image of the front camera 121A. The traveling direction image-generating unit 67, for example, when the traveling direction is forward, backward, leftward, and rightward, can select one from the captured images of the cameras 121A to 121D as a traveling direction image or can cut out an image corresponding to the traveling direction from an image obtained by integrating the captured images of the cameras 121A to 121D as a traveling direction image. The traveling direction image-generating unit 67, for example, when a predetermined instruction operation instructing the operating device 142 in forward or backward movement is not performed, may generate a traveling direction image corresponding to the forward direction of the undercarriage 110 based on the captured images of the one or the plurality of cameras 121A to 121D.

The display image-outputting unit 68 outputs the display image and the traveling direction image together with display instructions to the display part 145A.

(Operation Example of Display Control Device 61)

An operation example of the display control device 61 shown in FIG. 4 is described with reference to FIGS. 8 and 5. The processing shown in FIG. 8 is repeatedly executed at a predetermined cycle. When the processing shown in FIG. 8 is started, first, the overhead image-generating unit 63 generates an overhead image G20 (S1). Next, the upper swiveling body image-superimposing unit 64 superimposes a top image IM1 on the overhead image G20 (S2). Next, the reference line-superimposing unit 65 superimposes a reference line image m1 and a reference line image m2 on the overhead image G20 on which the top image IM1 has been superimposed (S3). Next, the crossline-superimposing unit 66 superimposes a crossline image L1 and a swiveling center image c1 on the overhead image G20 on which the top image IM1, the reference line image m1, and the reference line image m2 have been superimposed (this is a display image G21) (S4). Next, the traveling direction image-generating unit 67 generates a traveling direction image G22 (S5). Next, the display image-outputting unit 68 outputs the display image G21 and the traveling direction image G22 to the display part 145A and causes the display 145D to display the display image G21 and the traveling direction image G22 (S6).

(Function/Effect)

According to the present embodiment, the operator (i.e., the driver) can easily grasp an attention area accompanying the operation (i.e., the traveling and swiveling) of the work machine 100.

(Modification)

Next, modifications (i.e., a display image G21c and a display image G21d) of the display image G21 shown in FIG. 5 are described with reference to FIGS. 9 and 10. The display image G21c shown in FIG. 9 differs from the display image G21 shown in FIG. 5 in the following points. That is, the display image G21c shown in FIG. 9 does not include the reference image m1 and the reference image m2 shown in FIG. 5 but includes a reference image m3. The reference image m3 indicates an area that includes the entire area (i.e., an area Rm1 with shading in FIG. 9) inside the reference image m1, and the arrow image L11. In this case, the reference image m3 includes the swiveling attention area accompanying the swiveling of the upper swiveling body 120 and the traveling attention area accompanying the forward and backward movement of the undercarriage 110. That is, in the display image G21c shown in FIG. 9, the cross image L1 alone is an attention area image, and the reference image m3 alone is also an attention area image.

On the other hand, the display image G21d shown in FIG. 10 differs from the display image G21 shown in FIG. 5 in the following points. That is, the display image G21d shown in FIG. 10 does not include the reference image m1, the reference image m2, and the cross image L11 shown in FIG. 5 but includes a reference image m4. The reference image m4 shows an area having the same shape as the reference image m3 shown in FIG. 9. However, unlike the reference image m3, the reference image m4 indicates the orientation of the undercarriage 110 by changing the display mode between a reference image m4a corresponding to the upper half of the reference image m4 and a reference image m4b corresponding to the lower half thereof. The change in the display mode includes a difference in color, a difference in cycle of blinking display, a difference in thickness of dashed lines, and the like. In this case, the reference image m4 alone is an attention area image and indicates the orientation corresponding to the predetermined instruction operation of forward or backward movement for the operating device 142 that operates the undercarriage 110. In this case, the reference line-superimposing unit 65 corresponds to a “superimposing unit”, similarly to the crossline-superimposing unit 66.

Although the embodiments of the present invention are described above with reference to the drawings, the specific configuration is not limited to the above embodiments, and design changes and the like are included within the scope of the present invention.

For example, the work machine 100 according to the above embodiments is a hydraulic excavator, but the present disclosure is not limited thereto. For example, a work machine 100 according to another embodiment may be other work machines such as dump trucks, bulldozers, and wheel loaders.

Part or all of the program to be executed by the computer in the above embodiments can be distributed through computer-readable recording media or communication lines.

### INDUSTRIAL APPLICABILITY

According to each aspect of the present disclosure, a driver can easily grasp an area to pay attention accompanying the operation of a work machine.

### REFERENCE SIGNS LIST

100 . . . work machine
110 . . . undercarriage
120 . . . upper swiveling body
121A to 121D . . . camera
61 . . . display control device
62 . . . input/output unit
63 . . . overhead image-generating unit
64 . . . upper swiveling body image-superimposing unit
65 . . . reference line-superimposing unit
66 . . . crossline-superimposing unit
67 . . . traveling direction image-generating unit
68 . . . display image-outputting unit
L1 . . . cross image
m1, m2, m3, m4 . . . reference image
G20 . . . overhead image
G21 . . . display image
G22 . . . traveling direction image

1. A display control device, comprising:
an overhead image-generating unit that generates an overhead image around a work machine including an undercarriage and an upper swiveling body swivelably supported by the undercarriage based on one or a plurality of captured images imaged by one or a plurality of imaging devices provided in the upper swiveling body;
a superimposing unit that generates a display image in which an attention area image indicating a swiveling attention area accompanying swiveling of the upper swiveling body and a traveling attention area accompanying forward and backward movement of the undercarriage is superimposed on the overhead image; and
a display image-outputting unit that outputs the display image.

2. The display control device according to claim 1, wherein the attention area image shows information indicating a direction corresponding to a predetermined instruction operation of forward or backward movement for an operating device for operating the undercarriage.

3. The display control device according to claim 2, wherein
the attention area image includes
an image that shows an arrow indicating a length corresponding to the traveling attention area and a direction corresponding to the instruction operation, and
an image that shows a line crossing the arrow at a swiveling center of the work machine and indicating a length corresponding to the swiveling attention area.

4. The display control device according to claim 1, further comprising
a traveling direction image-generating unit that generates a traveling direction image corresponding to a traveling direction of the undercarriage based on the one or the plurality of captured images, wherein
the display image-outputting unit outputs the traveling direction image together with the display image.

5. A display control method, comprising:
a step of generating an overhead image around a work machine including an undercarriage and an upper swiveling body swivelably supported by the undercarriage based on one or a plurality of captured images imaged by one or a plurality of imaging devices provided in the upper swiveling body;
a step of generating a display image in which an attention area image indicating a swiveling attention area accompanying swiveling of the upper swiveling body and a traveling attention area accompanying forward and backward movement of the undercarriage is superimposed on the overhead image; and
a step of outputting the display image.

6. A work machine, comprising:
an undercarriage;
an upper swiveling body swivelably supported by the undercarriage;
one or a plurality of imaging devices provided in the upper swiveling body; and
a display control device, wherein
the display control device, includes:
an overhead image-generating unit that generates an overhead image around the upper swiveling body and the undercarriage based on one or a plurality of captured images imaged by the one or the plurality of imaging devices,
a superimposing unit that generates a display image in which an attention area image indicating a swiveling attention area accompanying swiveling of the upper swiveling body and a traveling attention area accompanying forward and backward movement of the undercarriage is superimposed on the overhead image, and
a display image-outputting unit that outputs the display image.

7. The display control device according to claim 2, further comprising
a traveling direction image-generating unit that generates a traveling direction image corresponding to a traveling direction of the undercarriage based on the one or the plurality of captured images, wherein
the display image-outputting unit outputs the traveling direction image together with the display image.

8. The display control device according to claim 3, further comprising
a traveling direction image-generating unit that generates a traveling direction image corresponding to a traveling direction of the undercarriage based on the one or the plurality of captured images, wherein
the display image-outputting unit outputs the traveling direction image together with the display image.
